(19) United States
(12) Patent Application Publication
(10) Pub. No.: US 2005/0186978 A1
(43) Pub. Date: Aug. 25, 2005

(54) Short message server and method using the same

(75) Inventor: Ching-Yu Lin, Hsinchu City (TW)

Correspondence Address: SNELL & WILMER;ONE ARIZONA CENTER, 400 EAST VAN BUREN, PHOENIX, AZ, 850040001, US

(73) Assignee: BENQ CORPORATION

(21) Appl. No.: 11/060,858

(22) Filed: Feb. 18, 2005

(30) Foreign Application Priority Data
Feb. 19, 2004 (TW) 93104098

(51) Int. Cl. H04Q 7/20

(52) U.S. Cl. 455/466; 455/422.1

(57) ABSTRACT

A short message server linked to a mobile telecommunication network is provided. The mobile telecommunication network provides communication between a first terminal and a second terminal. The short message server includes a processor, a memory, and a response module. The processor receives a short message from the first terminal and selectively relays the short message to the second terminal. The memory stores the short message. The response module selectively proceeds with a response to the short message according to a user configuration.

### CROSS-REFERENCE TO RELATED APPLICATIONS

This application claims the right of priority based on Taiwan Patent Application No. 093104098 entitled “Short Message Server”, filed on Feb. 19, 2004, which is incorporated herein by reference and assigned to the assignee herein.

### FIELD OF INVENTION

The present invention relates to a short message server, a mobile telecommunication network, and a method for handling a short message.

### BACKGROUND OF THE INVENTION

Forms of short messages on mobile phones are evolving from monotonous texts into multimedia formats to broaden the applications thereof. In the past, short message services communicated simple text messages between individuals, while current short message services are widely utilized to deliver information of stock index, news, weather reports, traffic, and the like.

In the GSM mobile telecommunication system, both a mobile terminal (e.g., a cellular phone) and a server linked to the mobile telecommunication system can launch short messages. Related technical specifications, standards, and protocols, such as GSM Technical Specifications 03.40 and 09.02, should be known to those skilled in the art and are, therefore, not included in this specification.

Generally, a short message server has two main functions, wherein one is to provide the temporary storage for short messages, and the other is to relay the short messages to the destination. After a short message is passed to the short message server, the short message is stored in the short message server. Thereafter, the short message server transmits the short message to the destination according to the routing information. In some cases, the short message can't reach the destination or can't be read by the destination device because, for example, the destination device does not support the format of the short message. Therefore, the short message server has to repeat the “re-delivery” process until the short message is successfully acknowledged by the destination. Before that, the server has to provide enough storage space for the short message. In addition, repeating the “re-delivery” causes the operating efficiency to degrade.

The short message delivery in mobile telecommunication networks resembles more or less the e-mail delivery over the Internet. Most e-mail systems utilize e-mail servers. Take an e-mail POP3 (Post Office Protocol) server for example. POP3 servers store e-mails temporally and transmit e-mails to the local hosts of the recipients. In response to the situations of “spam mails” and “computer viruses”, most POP servers allow users to establish “filters” so that e-mails can be handled at the servers, for example, including deleting or auto-replying to an e-mail with specified topics, instead of transmitting all e-mails to the local hosts.

To sum up, it is advantageous if the user can configure a short message server to respond to a short message based on some conditions before the short message is sent to the destination. It is more advantageous if the short message server can utilize less storage space and reduces the “re-delivery” process.

### SUMMARY OF THE INVENTION

The main aspect of the present invention is to provide a short message server and a method for handling a short message.

Another aspect of the present invention is to provide a short message server and a method for handling a short message in a mobile telecommunication network.

The server responds to a short message under some conditions based on a user configuration before the short message is sent to the destination. Thus the short message server needs less storage space and reduces the “re-delivery” process.

In one embodiment, disclosed is a short message server linked to a mobile telecommunication network. The mobile telecommunication network provides communication between a first terminal and a second terminal. The short message server includes a processor, a memory, and a response module. The processor receives a short message from the first terminal and selectively relays the short message to the second terminal. The memory stores the short message. The response module selectively proceeds with a response to the short message according to a user configuration.

A further aspect of the invention includes a mobile telecommunication network system for transmitting a short message from a first terminal to a second terminal. The mobile telecommunication network system includes a home location register (HLR), a mobile service switching center (MSC), and a short message server. The HLR generates routing information for the short message. The short message server includes a processor, a memory, and a response module. A short message from the first terminal is relayed to the second terminal by the processor via the HLR according to the routing information. The memory stores the short message. The response module selectively proceeds with a response to the short message according to a user configuration.

Another aspect of the invention includes a method for handling a short message by a short message server. The short message server is linked to a mobile telecommunication network, and the mobile telecommunication network provides communication between a first terminal and a second terminal. The method includes: (a) setting a user configuration; (b) receiving the short message from the first terminal, wherein the short message is prepared for the second terminal; (c) proceeding with a response responsive to the short message according to the user configuration.

The foregoing and other features of the invention will be apparent from the following more particular description of exemplary embodiments of the invention.

### BRIEF DESCRIPTION OF THE DRAWINGS

The present invention is illustrated by way of example and not intended to be limited by the figures of the accompanying drawing, in which like notations indicate similar elements.

FIG. 1a is an illustration of the short message server 10 according to an embodiment of the present invention;

FIG. 1b is an illustration of responses for the short message server 10 according to an embodiment of the present invention;

FIG. 2 is an illustration of the mobile telecommunication network system 200 according to an embodiment of the present invention; and

FIG. 3 is a flowchart of a method according to an embodiment of the present invention.

### DETAILED DESCRIPTION

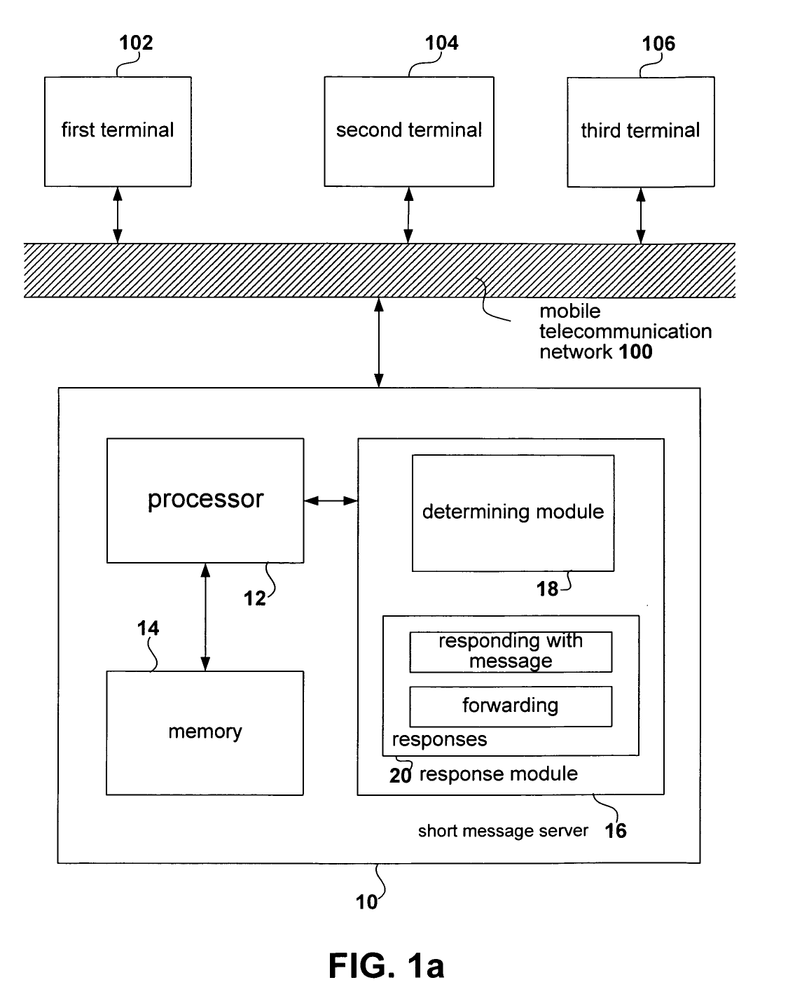

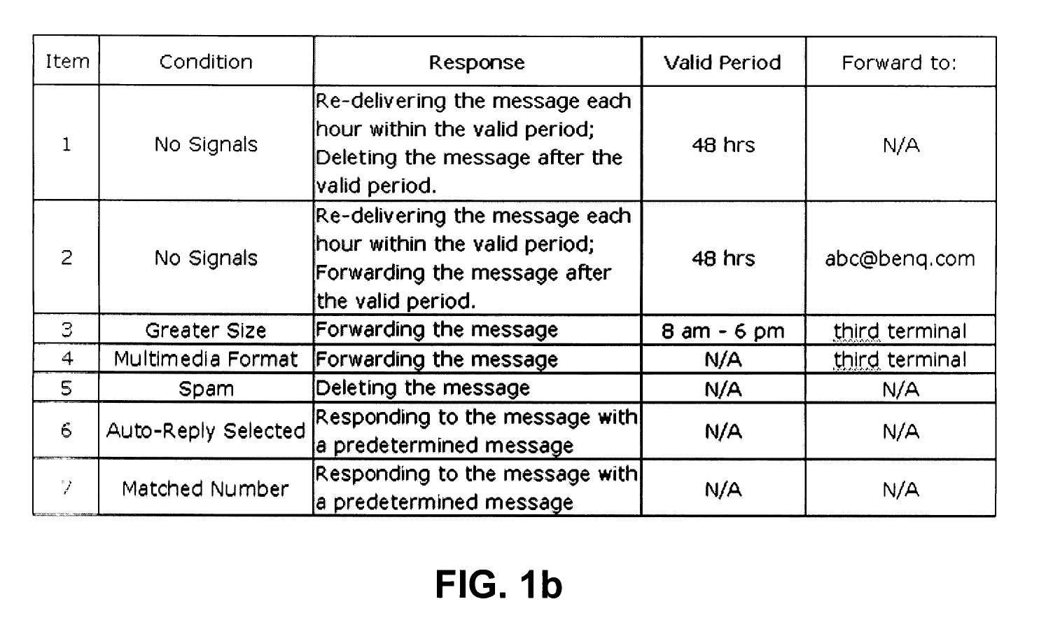

Referring to FIG. 1a, a short message server 10 is linked to a mobile telecommunication network 100. The mobile telecommunication network 100 provides communication between a first terminal 102 and a second terminal 104. The mobile telecommunication network 100 may be a GSM network, a PHS network, or other cellular networks. The first terminal 102 and the second terminal 104 are communication terminals supported by the telecommunication network 100. For example, the first terminal 102 and the second terminal 104 are GSM cellular phones, though the GSM network 100 can be linked to other non-mobile telecommunication networks (e.g., PSTN or a computer terminal) to connect the first terminal 102 and the second terminal 104. In another embodiment, the first terminal 102 is a fixed-line phone capable of short-messaging. In still another embodiment, the GSM network 100 is further connected to the Internet, and the first terminal 102 is an information device used for sending short messages via the Internet.

The short message server 10 includes a processor 12, a memory 14, and a response module 16. The processor 12 receives a short message from the first terminal 102 and selectively relays the short message to the second terminal 104. The memory 14 is connected to the processor 12 and stores the short message. The response module 16 selectively proceeds with a response to the short message according to a user configuration. In one embodiment, the short message is handled before being received by the second terminal 104 to reduce the unnecessary communication processes between the short message server 10 and the second terminal 104. Referring to FIG. 1b, in another embodiment, a format, content, a valid period or an activating condition of the response is selectively configured via the Internet or the mobile telecommunication network 100. Take item 6 of FIG. 1b, wherein the condition is “Auto-reply selected”, for example. After receiving the short message from the first terminal 102, the short message server 10 responds to the short message with a predetermined message. In this case, before proceeding with the response, the short message server 10 doesn't have to perform the processes, such as “paging”, “inquiring”, “routing”, and the like, in order to relay the short message to the second terminal 104. Another example is that when the second terminal 104 is lost, “auto-reply selected” is to send a replying message informing the suspend status to those who send messages to the lost second terminal 104. Referring to the item 7, “matched number”, of FIG. 1b, the memory 14 further stores a plurality of phone numbers and corresponding responses, wherein when the short message is assigned to a phone number corresponding to one of the phone numbers, the response module 16 proceeds with one of the corresponding responses. Preferably, the short message server 10 responds to incoming short messages of different phone numbers respectively with different predetermined messages. After that, the short message server 10 can further delete the short messages stored in the memory 14 to save the storage space.

Item 1, “no signal”, of FIG. 1b is applied when the second terminal 104 can't receive signals because, for example, it is temporarily located in the basement. As for item 1, a valid period (e.g., 48 hours) is configured. Within 48 hours after receiving the short message from the first terminal 102, the short message server 10 repeats re-delivering the short message to the second terminal 104 at each hour until the short message is successfully acknowledged. After the 48 hours, if the second terminal 104 still fails to receive the short message, the short message server 10 stops “re-delivery” and deletes the short message stored in the memory 14. For item 2, “no signal”, the short message server 10 forwards the short message to an e-mail account after the valid period. In items 3 and 4, the responses indicate forwarding the short message to the third terminal 106 (shown in FIG. 1a). When receiving the short message from the first terminal 102, the short message server 10 forwards the short message to the third terminal 106 instead of relaying it to the second terminal 104 and thus reduces the unnecessary communication processes between the short message server 10 and the second terminal 104. For instance, the response has a valid period from 8 am to 6 μm. During the valid period, the short message server 10 forwards all messages, originally prepared for the second terminal 104, to the third terminal 106. The third terminal 106 can be a cellular phone or an information device with mobile communication functions. In one embodiment, the third terminal 106 is linked to the telecommunication network 100 via a non-mobile telecommunication network (e.g., PSTN or the Internet) to communicate with the short message server 10. Under the embodiment, the third terminal 106 is a fixed-line phone supporting short messages or an information device used for sending short messages via the Internet.

In addition to exemplary embodiments shown in FIG. 1b, the responses “Forwarding the message” and “Responding to the message with a predetermined message” can associate with other activating conditions. In one embodiment, the processor 12 starts the processes for relaying the short message to the second terminal 104 on receiving the short message from the first terminal 102. After a predefined period, if the second terminal 104 still fails to receive the short message, the response module 16 proceeds with the responses “Forwarding the message” or “Responding to the message with a predetermined message”. For example, after 48 hours of the short message server 10 receiving the short message from the first terminal 102, the second terminal 104 still fails to receive the short message because of (1) there is no connection signal; (2) the second terminal 104 is off; (3) the storage space of the second terminal 104 is insufficient; (4) the size of the short message is greater than a predetermined size; (5) the second terminal 104 doesn't support the format of the short message (e.g., a multimedia message); and the like, then the response module 16 replies to the first terminal 102 with a predetermined message, or forwards the short message to the third terminal 106.

Referring back to FIG. 1b, item 3 is applied when the size of the short message is greater than a predetermined size (e.g., 30 kb), and the short message server 10 forwards the short message. In item 4, the short message server 10 forwards the short message when the second terminal 104 doesn't support the format of the short message. For both item 3 and 4, the short message server 10 can further reply to the first terminal 102 with a report message about the actual conditions. As for item 5, when the short message from the first terminal 102 is recognized as a “spam” message, the short message server 10 deletes the short message.

The response module 16 includes a determining module 18 for perceiving a receiving status from the second terminal 104 responsive to the short message. The receiving status may be that there is no connection signal; the second terminal 104 is off; the storage space of the second terminal 104 is insufficient; the size of the short message is greater than a predetermined size; the second terminal 104 doesn't support the format of the short message (e.g., a multimedia message); or the like. In one embodiment, the determining module 18 launches an inquiring signal in advance to perceive the receiving status so that the response module 16 can proceed with the response immediately rather than wait for a predetermined period of time. The inquiring signal can be launched periodically or at times when the second terminal 104 is turned on and registers with the mobile telecommunication network 100.

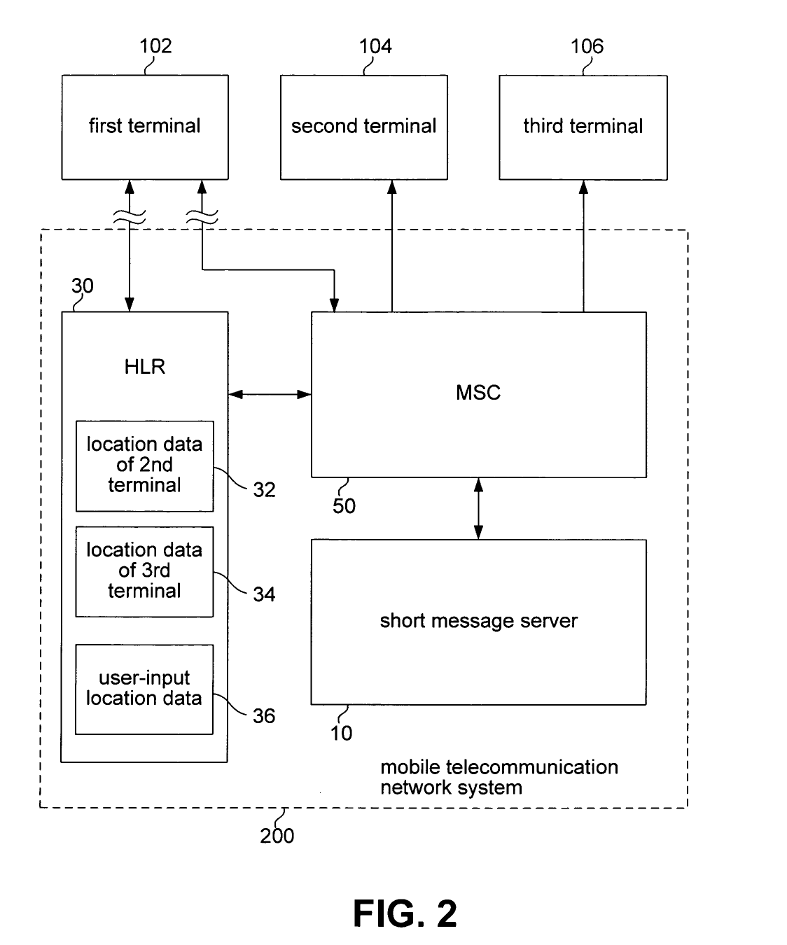

Referring to FIG. 2, a mobile telecommunication network system 200 is provided for transmitting a short message from a first terminal 102 to a second terminal 104. The mobile telecommunication network system 200 includes a home location register (HLR) 30, a mobile service switching center (MSC) 50, and a short message server 10. The HLR 30 stores the location data 32 of the second terminal 104 and generates routing information for the short message. The MSC 50 includes a visitor location register (not shown) for providing the location information 32 of the second terminal 104 to the HLR 30. It should be noted that, typically, the mobile telecommunication network system 200 may include a plurality of MSC 50. Each MSC 50 provides services in the specific area. The short message server 10 includes a processor 12 (as shown in FIG. 1a). A short message from the first terminal 102 is relayed to the second terminal 104 by the processor 12 via the HLR 30 according to the routing information. The short message server 10 selectively proceeds with a response to the short message according to a user configuration.

In one embodiment, the mobile telecommunication network system 200 can be linked to other non-mobile telecommunication networks to connect the first terminal 102 and the second terminal 104. A format, content, a valid period or an activating condition of the response is selectively configured via the Internet or the mobile telecommunication network system 200. In another embodiment, the HLR 30 further stores the location data 34 of the third terminal 106 provided by the visitor location register, and thus the response “forwarding the message” can be selected and performed. The short message server 10 also includes a determining module 18 (as shown in FIG. 1a) for perceiving a receiving status from the second terminal 104 responsive to the short message. The receiving status may be that there is no connection signal; the second terminal 104 is turned off; the storage space of the second terminal 104 is insufficient; the size of the short message is greater than a predetermined size; the second terminal 104 doesn't support the format of the short message (e.g., a multimedia message); or the like. Therefore the short message server 10 can proceed with the response immediately.

In addition, a user-input location data 36 is input by the user rather than provided by the visitor location register. The HLR 30 is provided for storing the user-input location data 36 and for generating routing information for the short message based on the user-input location data 36. The routing information guides the short message to reach the specified short message server 10. Therefore the short message server 10 receives the short message from the first terminal 102 and proceeds with the response.

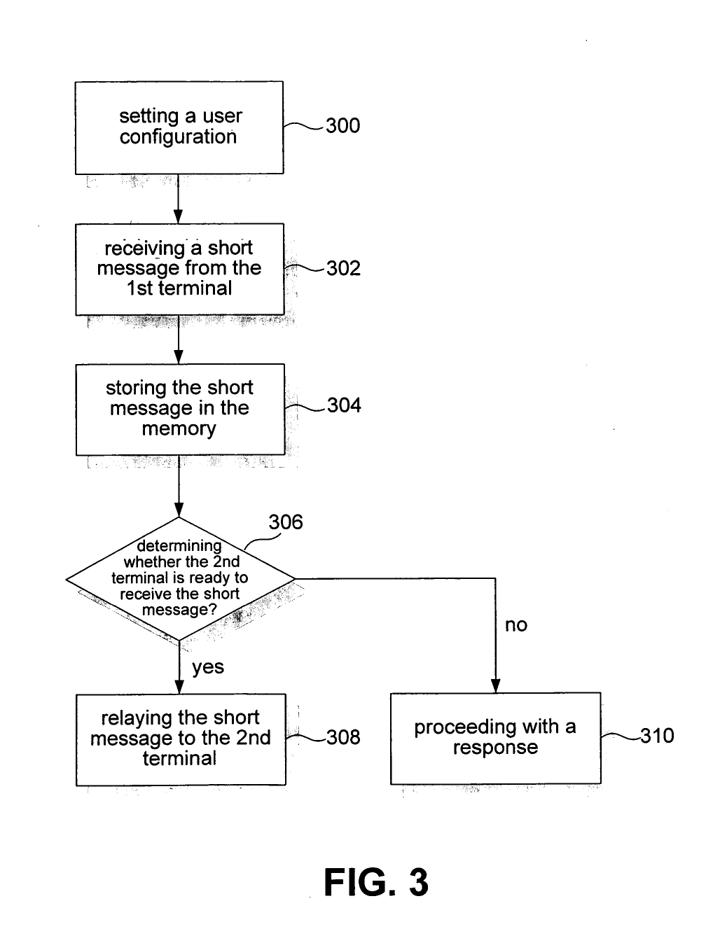

With reference to the short message server 10 in FIG. 1a, FIG. 3 is a flowchart of a method according to an embodiment of the present invention. It begins with the step 300 setting a user configuration. In the step 300, a format, content, a valid period, or an activating condition of a response is selectively configured via the Internet or the mobile telecommunication network 100 (shown in FIG. 1). Then in the step 302, the processor 12 receives the short message from the first terminal 102, wherein the short message is prepared for the second terminal 104. The step 304 is to store the short message in the memory 12. Next, it turns to the step 306 perceiving a receiving status from the second terminal 104 responsive to the short message and determining whether the second terminal 104 is ready to receive the short message. The receiving status may indicate that there is no connection signal; the second terminal 104 is off; the storage space of the second terminal 104 is insufficient; the size of the short message is greater than a predetermined size; the second terminal 104 doesn't support the format of the short message (e.g., a multimedia message); or the like. The determining module 18 launches an inquiring signal in advance to perceive the receiving status. If “Yes” in the step 306, it goes to the step 308 relaying the short message to the second terminal 104. If “No” in the step 306, it goes to the step 310 proceeding with a response responsive to the short message according to the user configuration. The examples of the response may be referred in FIG. 1b.

In one embodiment, the user configuration of the step 300 includes a valid period for each condition. After the valid period of time elapses after the step 302, if the receiving status indicates that the second terminal 104 is not ready to receive the short message in the step 306, the response module 16 proceeds with the response responsive to the short message according to the user configuration in the step 310. In another embodiment, referring to FIG. 2, where the mobile telecommunication network system includes a HLR 30, the method further includes generating routing information for the short message based on a user-input location data input in the step 300. The routing information guides the short message to reach the short message server 10 which is assigned by the user. Therefore the short message server 10 receives the short message from the first terminal 102 in the step 302.

While this invention has been described with reference to the illustrative embodiments, these descriptions should not be construed in a limiting sense. Various modifications of the illustrative embodiments, as well as other embodiments of the invention, will be apparent upon reference to these descriptions. It is therefore contemplated that the appended claims will cover any such modifications or embodiments as falling within the true scope of the invention and its legal equivalents.

1. A short message server connecting to a cellular network, said cellular network providing communication between a first terminal and a second terminal, said short message server comprising:
a processor for receiving a short message from said first terminal and selectively relaying said short message to said second terminal;
a memory connected to said processor, for storing said short message; and
a response module connected to said processor, for selectively proceeding with a response to said short message according to a user configuration.

2. A short message server according to claim 1, wherein said response module comprises a determining module for perceiving a receiving status of said second terminal responsive to said short message, and for selecting said response based on said receiving status.

3. A short message server according to claim 2, wherein, when said receiving status indicates said second terminal is unable to receive said short message, said response includes automatically responding to said first terminal with a predetermined message.

4. A short message server according to claim 1, wherein said memory further stores a plurality of phone numbers and corresponding responses, wherein when said short message is assigned to a phone number corresponding to one of said phone numbers, said response module proceeds with one of said corresponding responses.

5. A short message server according to claim 1, wherein a format, a content, a valid period, or an activating condition of said response is selectively configured via the Internet or said mobile telecommunication network.

6. A short message server according to claim 1, wherein said mobile telecommunication network is further connecting to a third terminal, wherein said response includes forwarding said short message to said third terminal.

7. A short message server according to claim 6, wherein said second terminal is unable to support a format of said short message.

8. A short message server according to claim 6, wherein a size of said short message is greater than a predetermined size.

9. A mobile telecommunication network system for transmitting a short message from a first terminal to a second terminal, said mobile telecommunication network system comprising:
a home location register (HLR) for providing a routing information for said short message;
a mobile service switching center (MSC) linked to said HLR; and
a short message server linked to said MSC, said short message server comprising:
a processor for receiving a short message from said first terminal, and for relaying said short message to said second terminal, the short message sending to the processor according to said routing information;
a memory, connected to said processor, for storing said short message; and
a response module, connected to said processor, for proceeding with a response to said short message according to a user configuration.

10. A mobile telecommunication network system according to claim 9, wherein said response module comprises a determining module for perceiving a receiving status from said second terminal responsive to said short message, and for selecting said response based on said receiving status.

11. A mobile telecommunication network system according to claim 10, wherein, when said receiving status indicates said second terminal being unable to receive said short message, said response includes automatically responding to said first terminal with a predetermined message.

12. A mobile telecommunication network system according to claim 9, wherein said memory further stores a plurality of phone numbers and corresponding responses, wherein when said short message is assigned to a phone number corresponding to one of said phone numbers, said response module proceeds with one of said corresponding responses.

13. A mobile telecommunication network system according to claim 9, wherein a format, a content, a valid period, or an activating condition of said response is selectively configured via the Internet or said mobile telecommunication network system.

14. A mobile telecommunication network system according to claim 9, wherein said mobile telecommunication network system is further linked to a third terminal, wherein said response includes forwarding said short message to said third terminal.

15. A mobile telecommunication network system according to claim 9, wherein said HLR generates said routing information based on said user configuration, and said short message server receives said short message from said first terminal according to said routing information.

16. A method for handling a short message by a short message server, said short message server being linked to a mobile telecommunication network, said mobile telecommunication network providing communication between a first terminal and a second terminal, said method comprising:
(a) setting a user configuration;
(b) receiving said short message from said first terminal, said short message is for said second terminal; and
(c) proceeding with a response responsive to said short message according to said user configuration.

17. A method according to claim 16, said short message server comprising a memory, said method subsequent to the step (b) further comprising:
(d) storing said short message in said memory; and
(e) relaying said short message to said second terminal;
wherein the step (c) further comprises:
(f) proceeding with said response according to said user configuration if a predetermined period of time has elapsed before said short message reaches said second terminal.

18. A method according to claim 16, said method further comprising:
(g) perceiving a receiving status from said second terminal responsive to said short message.

19. A method according to claim 16, wherein step (a) comprises:
(h) selectively configuring a format, a content, a valid period and an activating condition of said response via the Internet or said mobile telecommunication network.

20. A method according to claim 16, wherein step (c) comprises:
(i) responding to said first terminal with a predetermined message.

21. A method according to claim 16, said mobile telecommunication network further linked to a third terminal, wherein said response includes forwarding said short message to said third terminal.

22. A method according to claim 16, said mobile telecommunication network comprising a home location register, said home location register generating said routing information by said home location register based on said user configuration, and said short message server receiving said short message from said first terminal according to said routing information.
